(19) United States
(12) Patent Application Publication
(10) Pub. No.: US 2013/0319064 A1
(43) Pub. Date: Dec. 5, 2013

(54) HEAT SINK FABRICATION METHOD

(71) Applicant: Yi-Kun LIN, New Taipei City (TW)

(72) Inventor: Yi-Kun LIN, New Taipei City (TW)

(73) Assignee: DONG GUAN YUNG TENG ELECTRONIC PRODUCTS CO., LTD., Dong Guan City (TW)

(21) Appl. No.: 13/488,061

(22) Filed: Jun. 4, 2012

(51) Int. Cl. B23P 15/26

(52) U.S. Cl. 72/255

(57) ABSTRACT

A heat sink fabrication method includes the step of heating aluminum billets into malleable aluminum and then extruding malleable aluminum into an aluminum substrate bar having different lengths of fins radially spaced around the periphery thereof, the step of using a machine to transversely cut the aluminum substrate bar into multiple aluminum substrates subject to a predetermined thickness, and the step of employing a stamping technique to stamp each aluminum substrate into a heat sink having radiation fins extended from and spaced around a plate-shaped base portion thereof.

### BACKGROUND OF THE INVENTION

1. Field of the Invention

The present invention relates to heat sink fabrication technology and more particularly, to a heat sink fabrication method for making a heat sink using extruding and stamping techniques that simplifies heat sink fabrication, reduces tooling costs, and ensures high dimensional precision of the product.

2. Description of the Related Art

Following fast development of computer technology, powerful, high-speed, inexpensive computers with large capacities have been continuously created. In consequence, computer related applications have also been well developed. As clock frequencies in digital circuits and voltage applied increase, the heat generated by components running at the higher performance levels also increases. It requires more effective cooling to avoid damaging the hardware by overheating. Many heat sinks have been created for the purposes of cooling computer components.

A heat sink may be directly attached to an electronic component (such as CPU, video card, chip, etc.) to hold an electric fan for quick dissipation of waste heat. FIG. 9 illustrates a conventional heat sink for this purpose. As illustrated, the heat sink A is a one-piece member made by an extruding, molding or milling process, comprising a flat base A1, a plurality of upright radiation fins A2 upwardly extended from the flat base A1, and a fan accommodation chamber A0 surrounded by the radiation fins A2. The radiation fins A2 may be arranged in a radial manner, or in one or two directions. According to this design, the radiation fins A2 have a certain thickness and weight. The material and tooling costs of this design of heat sink are high. The application of this design of heat sink is also limited. It cannot be used for dissipating heat from certain chips. In order to increase the surface area of the radiation fins for better heat dissipation performance, the height or density of the arrangement of the radiation fins must be relatively increased. However, increasing the height or density of the arrangement of the radiation fins will also increase the tooling costs. Further, a secondary milling or cutting procedure is necessary for making the fan accommodation chamber A0. The formation of the fan accommodation chamber A0 produces a large amount of waste material. After formation of the fan accommodation chamber A0, further cleaning and polishing steps must be performed, consuming much time and labor.

FIG. 10 illustrates another conventional design of heat sink. According to this design, a metal plate member is processed into a heat sink using stamping and bending techniques. The heat sink A comprises a flat base A1, a plurality of upright radiation fins A2 extended from and spaced around the border area of the flat base A1, a plurality of through holes A3 cut through the flat base A1, and a fan accommodation chamber A0 surrounded by the upright radiation fins A2 for accommodating an electric fan. This design of heat sink has poor performance. During operation of the electric fan in the fan accommodation chamber A0, the upright radiation fins A2 form a barrier to stop the produced flow of air. Thus, air resistance will be created around the border area and bottom side of the heat sink A, lowering the heat dissipation performance of the heat sink A.

### SUMMARY OF THE INVENTION

The present invention has been accomplished under the circumstances in view. It is one object of the present invention to provide a heat sink fabrication method, which is practical for making a heat sink that can efficiently dissipate waste heat from a heat source without causing much air resistance or noises. It is another object of the present invention to provide a heat sink fabrication method, which simplifies the heat sink fabrication process, greatly reduces tooling costs, and ensures high dimensional precision of the product.

To achieve this and other objects of the present invention, a heat sink fabrication method includes the steps of (i) heating aluminum billets into malleable aluminum and then extruding malleable aluminum into an aluminum substrate bar having different lengths of fins radially spaced around the periphery thereof, (ii) using a machine to transversely cut the aluminum substrate bar into multiple aluminum substrates subject to a predetermined thickness, and (iii) employing a stamping technique to stamp each aluminum substrate into a heat sink having radiation fins extended from and spaced around a plate-shaped base portion thereof.

Further, the different lengths of fins of the aluminum substrate bar produced are alternatively arranged around the periphery of the aluminum substrate bar in a 1 long 1 short, 1 long 2 short, 2 long 1 short, or 2 long 2 short manner. Thus, when each aluminum substrate bar is stamped into a heat sink, the different lengths of fins are changed into radiation fins that are alternatively arranged at different elevations

Further, the heat sink thus made defines a recessed accommodation chamber surrounded by the plate-shaped base portion and the radiation fins and a heat dissipation passage between each two adjacent radiation fins in air communication with the recessed accommodation chamber.

Further, the heat sink thus made comprises a plurality of mounting lugs extended from the plate-shaped base portion, and at least one mounting through hole in each mounting lug for fastening to a board member (main board, display card, or expansion card) by fastening members, for example, screws.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a flow chart of a heat sink fabrication method in accordance with the present invention.

FIG. 2 is a schematic drawing illustrating the architecture of an extruding machine for the fabrication of a heat sink in accordance with the present invention.

FIG. 3 is a schematic front view of an aluminum substrate bar according to the present invention.

FIG. 4 is a schematic side view illustrating a cutting process applied to an aluminum substrate bar according to the present invention.

FIG. 5 is a schematic drawing illustrating an aluminum substrate stamped into a heat sink according to the present invention.

FIG. 6 is an oblique top elevational view of a heat sink made according to the present invention.

FIG. 7 is an exploded view of an electric fan and a heat sink according to the present invention.

FIG. 8 is an exploded view, illustrating an application example of the present invention.

FIG. 9 is an oblique elevational view of a heat sink according to the prior art.

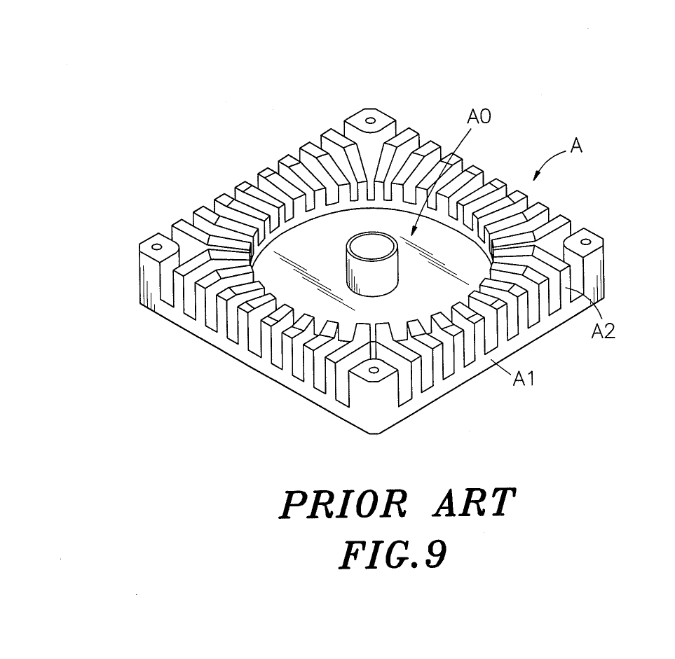

FIG. 10 is an oblique elevational view of another structure of heat sink according to the prior art.

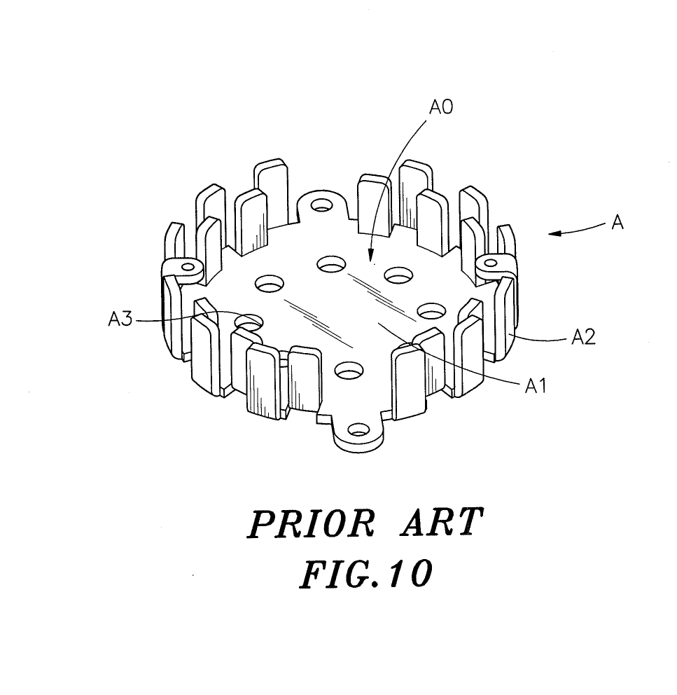

### DETAILED DESCRIPTION OF THE PREFERRED EMBODIMENT

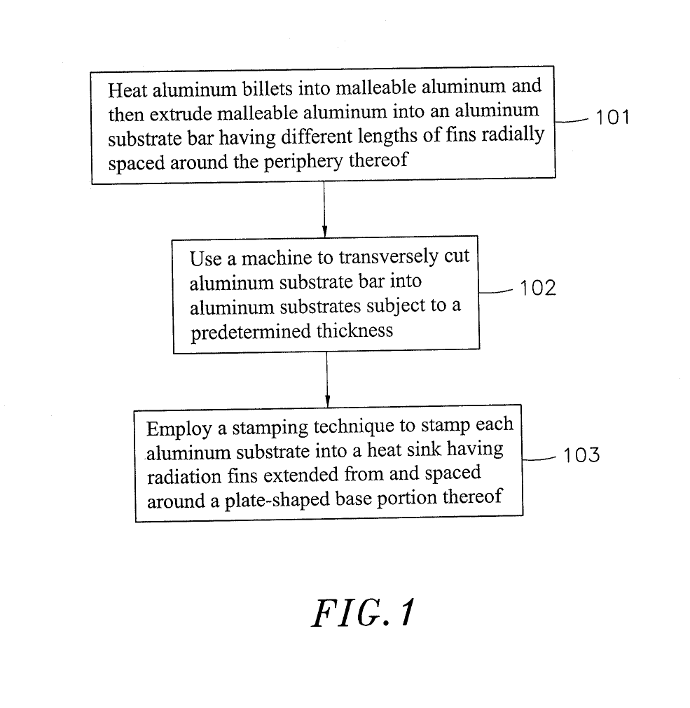

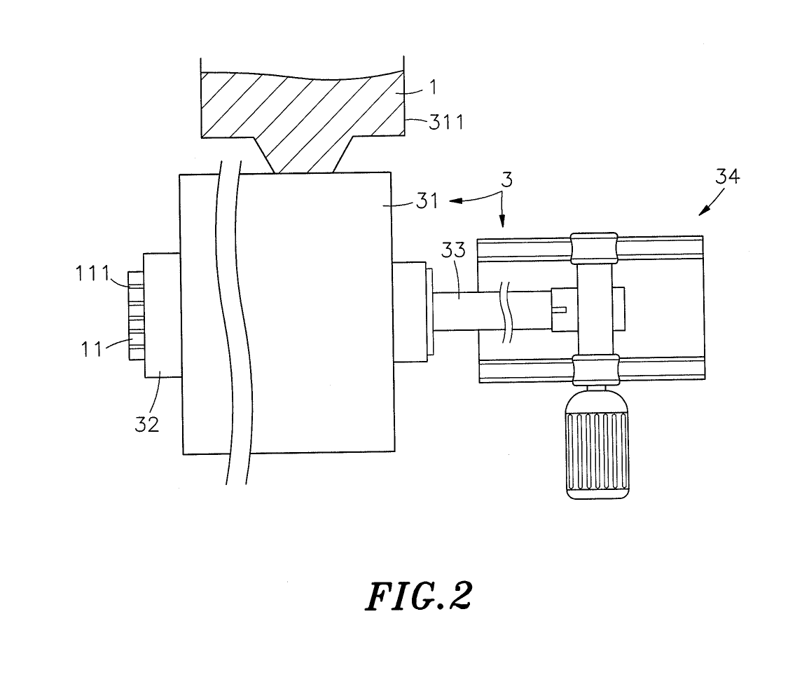

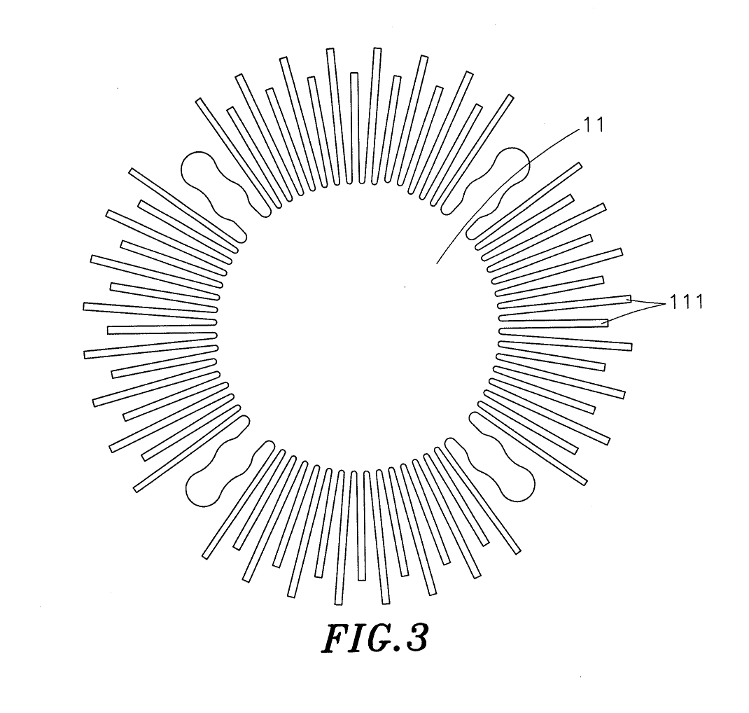

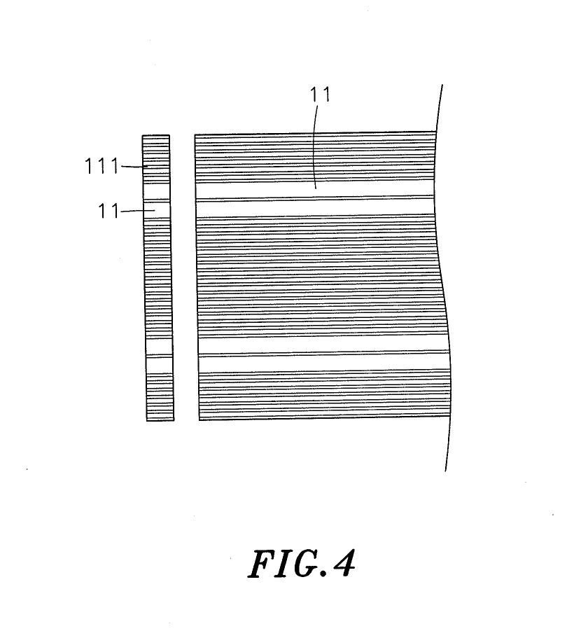

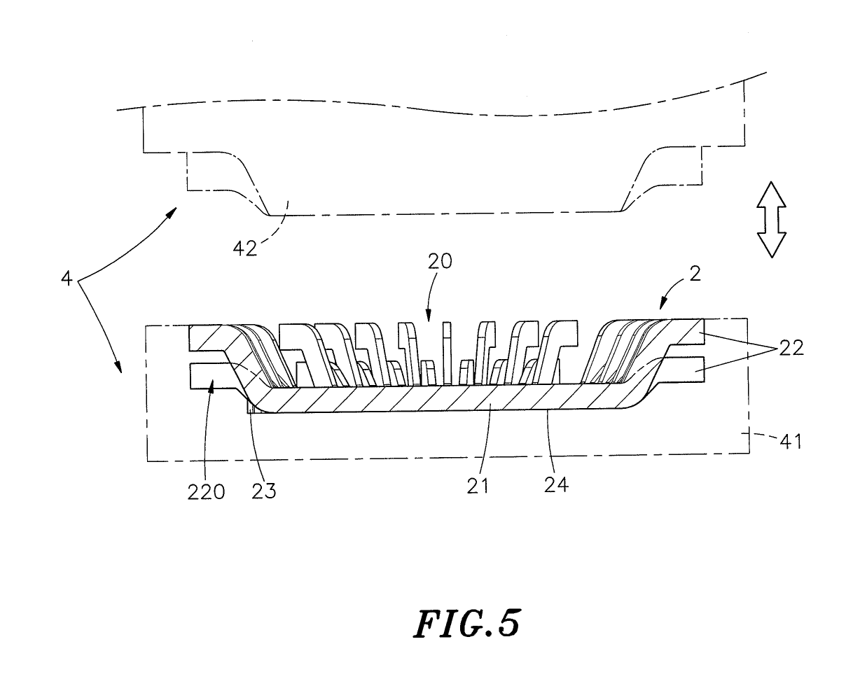

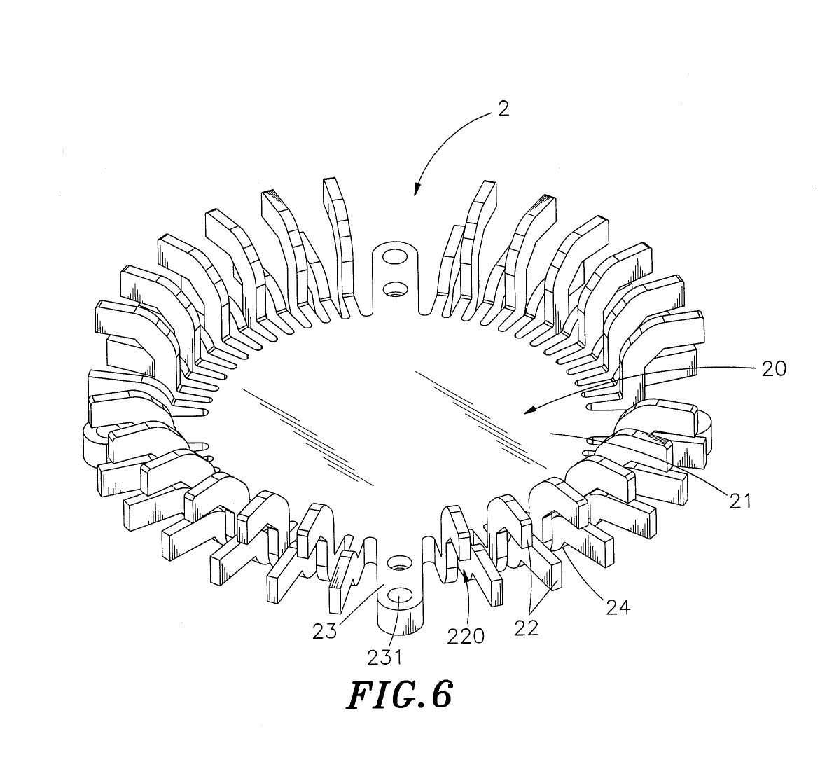

Referring to FIGS. 1-6, a heat sink fabrication method in accordance with the present invention comprises the steps of:
(101) heating aluminum billets into malleable aluminum 1 and then extruding malleable aluminum 1 into an aluminum substrate bar 11 having different lengths of fins 111 radially spaced around the periphery thereof;
(102) using a machine to transversely cut the aluminum substrate bar 11 into multiple aluminum substrates 11 subject to a predetermined thickness; and
(103) employing a stamping technique to stamp each aluminum substrate 11 into a heat sink 2 having radiation fins 22 extended from and spaced around a plate-shaped base portion 21 thereof.

During fabrication, aluminum billets are prepared and heated into a molten condition, and then molten aluminum 1 is put in a hopper 311 of an extruding machine 3 and fed into an extruder unit 31 where aluminum 1 is maintained in a malleable condition, and a screw 33 is rotated by a motor drive 34 to force malleable aluminum 1 through an extrusion die 32, forming an aluminum substrate bar 11 having two different lengths of fins 111 alternatively and radially spaced around the periphery thereof. The application of this extrusion process simplifies the fabrication of the heat sink and ensures high dimensional precision of the product. Further, the extrusion process can be selected from the techniques of direct extrusion, indirect extrusion, hydrostatic extrusion or impact extrusion. Since the extrusion process for making the aluminum substrate bar 11 subject to a predetermined configuration and the detailed structure of the extruding machine 3 are of the known art, no further detailed description in this regard will be described.

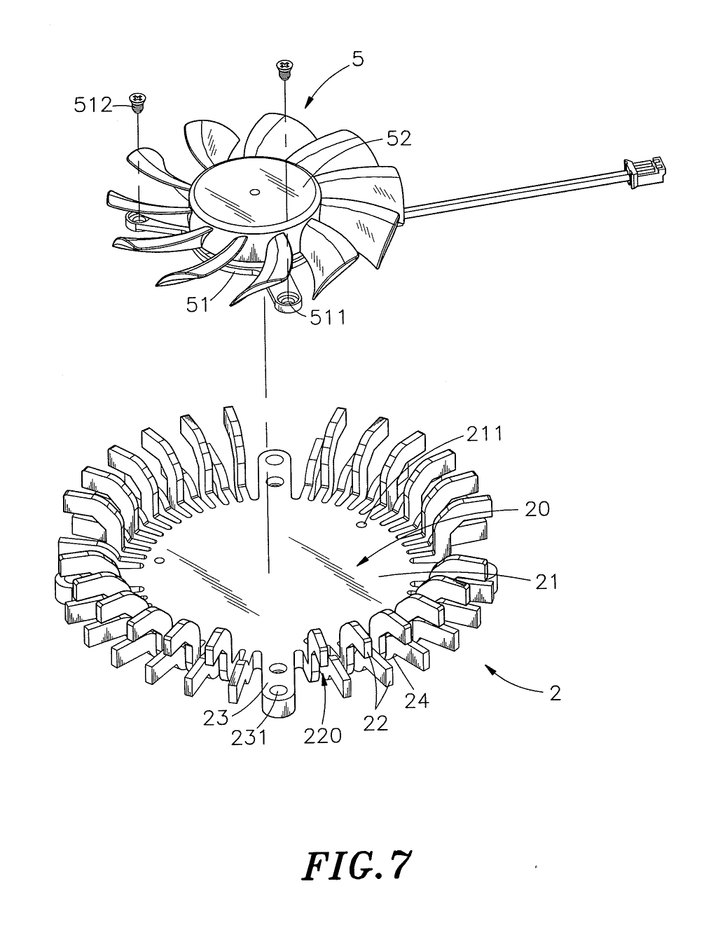

Thereafter, a cutting tool, for example, milling machine or circular saw is used to cut the aluminum substrate bar 11 into multiple aluminum substrates 11 subject to a predetermined thickness, for example, 3-5 mm, or preferably 4 mm. Thereafter, each individual aluminum substrate 11 is put in a die member 41 of a stamping press 4, and then stamped, by a press head 42, into a heat sink 2 having radiation fins 22 extended from and spaced around a plate-shaped base portion 21 thereof. The radiation fins 22 are alternatively arranged at different elevations. Further, the heat sink 22 defines a recessed accommodation chamber 20 that is surrounded by the plate-shaped base portion 21 and the radiation fins 22, and a heat dissipation passage 220 between each two adjacent radiation fins 22 in air communication with the recessed accommodation chamber 20. The recessed accommodation chamber 20 is adapted for accommodation a fan 5 (see FIG. 7). By means of employing a stamping technique to process each individual aluminum substrate 11 into a heat sink 2, the invention effectively saves material consumption and heat sink fabrication cost. During the fabrication of the heat sink 2, no further secondary milling or hole-cutting procedure is necessary. Further, the application of the stamping technique assures perfect heat sink surface flatness, high precision of cross section, and high product quality and yield.

Further, the different lengths of fins 111 of the aluminum substrate bar 11 can be alternatively arranged around the periphery of the aluminum substrate bar 11 in a 1 long 1 short, 1 long 2 short, 2 long 1 short, or 2 long 2 short manner. After processed through the aforesaid stamping process, the different lengths of fins 111 are changed into radiation fins 22. In this embodiment, the radiation fins 22 are curve-shaped and radially extended from the border area of the plate-shaped base portion 21 and alternatively arranged at two different elevations. However, this radiation fin arrangement is not a limitation. For example, the curve-shaped radiation fins 22 can be arranged at a same elevation. Alternatively, the curve-shaped radiation fins 22 can be arranged in multiple groups at different elevations. The heat sink 2 thus made further comprises multiple mounting lugs 23 and mounting through holes 231 in the mounting lugs 23 for the mounting of a board member (main board, display card, or expansion card). The mounting lugs 23 and mounting through holes 231 are formed upon formation of the heat sink 2 by means of the stamping press 4.

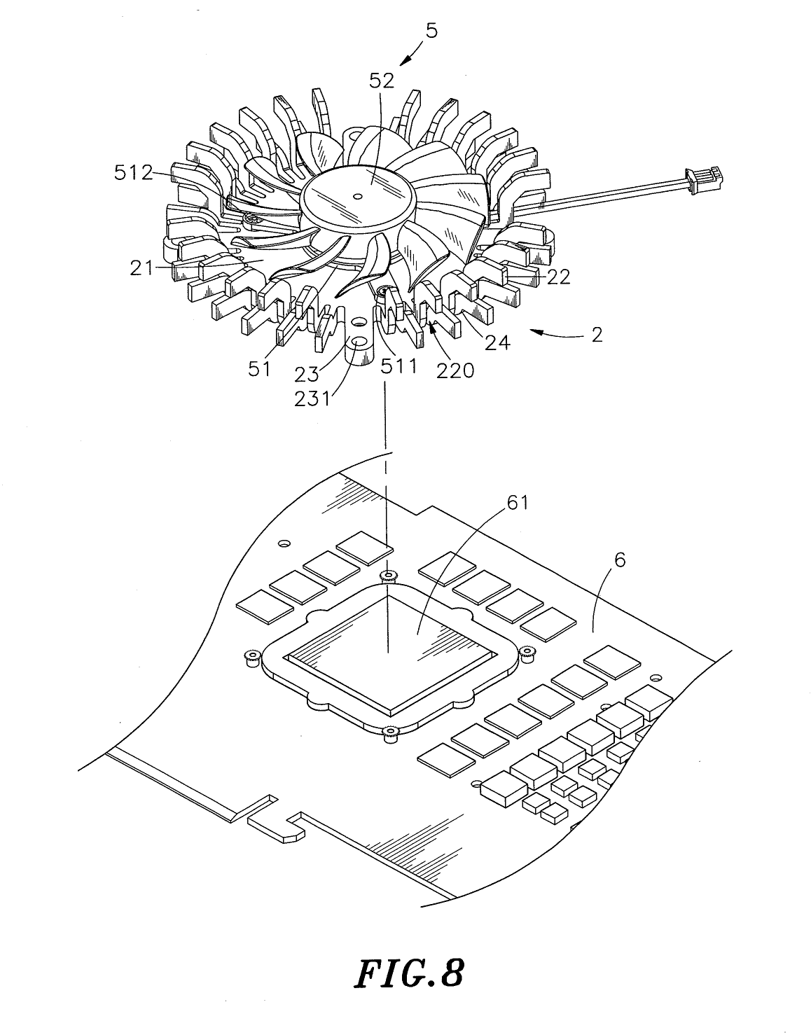

Referring to FIGS. 7 and 8, an application example of the present invention is shown. As illustrated, mounting holes 211 are formed in the plate-shaped base portion 21 of the heat sink 2 by a drilling or milling process. At least one, for example, one electric fan 5 is accommodated in the recessed accommodation chamber 20 of the heat sink 2. The electric fan 5 comprises a fan holder 51 and a fan body 52. The fan holder 51 comprises a plurality of through holes 511 respectively fastened to the mounting holes 211 of the heat sink 2 by respective screws 512. This electric fan mounting method is simply an example of the present invention and shall not be regarded as a limitation. Other measures may be selectively employed to affix an electric fan to the heat sink 2.

Further, the mounting through holes 231 of the mounting lugs 23 of the heat sink 2 are affixed to a circuit board 6 by respective fastening members (not shown) to keep a bottom contact surface 24 of the plate-shaped base portion 21 in contact with the surface of a heat source 61 (CPU, video card, chip, etc) at the circuit board 6. During operation of the circuit board 6, the plate-shaped base portion 21 of the heat sink 2 absorbs waste heat generated by the heat source 61, enabling absorbed waste heat to be rapidly dissipated into the air through the radiation fins 22.

Further, the flow of air produced during rotation of the electric fan 5 goes toward the radiation fins 22 in a clockwise or counter-clockwise direction. Since the radiation fins 22 are arranged at different elevations, a large amount of air goes through the heat dissipation passages 220 during rotation of the electric fan 5 to efficiently carry waste heat away from the radiation fins 22 without causing much air resistance or noises. Thus, the use of the heat sink 2 with the electric fan 5 can rapidly and efficiently carry waste heat away from the circuit board 6.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A heat sink fabrication method, comprising the steps of:
(i) heating aluminum billets into malleable aluminum and then extruding said malleable aluminum into an aluminum substrate bar having different lengths of fins radially spaced around the periphery thereof;
(ii) using a machine to transversely cut said aluminum substrate bar into multiple aluminum substrates subject to a predetermined thickness; and
(iii) employing a stamping technique to stamp each said aluminum substrate into a heat sink having radiation fins extended from and spaced around a plate-shaped base portion thereof.

2. The heat sink fabrication method as claimed in claim 1, wherein said different lengths of fins of said aluminum substrate bar produced during step (i) are alternatively arranged around the periphery of said aluminum substrate bar in one of the conditions of 1 long 1 short, 1 long 2 short, 2 long 1 short, and 2 long 2 short.

3. The heat sink fabrication method as claimed in claim 1, wherein said aluminum substrate bar is cut into multiple aluminum substrates, during step (ii), subject to a predetermined thickness within the range of 3-5 mm by means of one of the cutting tools of milling machine and circular saw.

4. The heat sink fabrication method as claimed in claim 1, wherein the radiation fins of said heat sink made during step (iii) are alternatively arranged at two different elevations.

5. The heat sink fabrication method as claimed in claim 1, wherein the radiation fins of said heat sink made during step (iii) are partially arranged a first elevation and partially arranged at a second elevation.

6. The heat sink fabrication method as claimed in claim 1, wherein the radiation fins of said heat sink made in step (iii) are arranged at a same elevation.

7. The heat sink fabrication method as claimed in claim 1, wherein the heat sink made in step (iii) defines a recessed accommodation chamber surrounded by said plate-shaped base portion and said radiation fins and a heat dissipation passage between each two adjacent radiation fins in air communication with said recessed accommodation chamber.

8. The heat sink fabrication method as claimed in claim 1, wherein the heat sink made in step (iii) comprises a plurality of mounting lugs extended from said plate-shaped base portion, and at least one mounting through hole in each said mounting lug.

9. The heat sink fabrication method as claimed in claim 1, wherein the heat sink made in step (iii) comprises a plurality of mounting holes formed in said plate-shaped base portion.
